(19) United States
(12) Patent Application Publication
(10) Pub. No.: US 2026/0060330 A1
(43) Pub. Date: Mar. 5, 2026

(54) AEROSOL GENERATING DEVICE AND METHOD OF CONTROLLING AEROSOL GENERATING DEVICE

(71) Applicant: KT&G CORPORATION, Daejeon (KR)

(72) Inventors: Jae Min LEE, Gyeonggi-do (KR); Sang Kyu PARK, Seoul (KR)

(73) Assignee: KT&G CORPORATION, Daejeon (KR)

(21) Appl. No.: 19/278,992

(22) Filed: Jul. 24, 2025

(30) Foreign Application Priority Data
Aug. 29, 2024 (KR) 10-2024-0116817
Nov. 1, 2024 (KR) 10-2024-0153685

(51) Int. Cl. A24F 40/57; A24F 40/465; A24F 40/51; A24F 40/53; H05B 6/04; H05B 6/06; H05B 6/10

(52) U.S. Cl. CPC A24F 40/57; A24F 40/465; A24F 40/51; A24F 40/53; H05B 6/04; H05B 6/06; H05B 6/105

(57) ABSTRACT

Provided are an aerosol generating device and a method of controlling the aerosol generating device. The aerosol generating device and the method include sensing, by a current sensing unit connected between a DC/DC converter and a power conversion unit, the DC current output from the DC/DC converter, performing, by a controller, temperature monitoring for estimating, based on the sensed DC current, a temperature of a susceptor of a heating unit and power monitoring for estimating, based on the sensed DC current, power supplied from the DC/DC converter to the power conversion unit, and performing, by the controller, at least one of temperature-based feedback control and power-based feedback control for the DC/DC converter, based on results of the temperature monitoring and the power monitoring.

### CROSS-REFERENCE TO RELATED APPLICATIONS

This application is based on and claims priority under 35 U.S.C. § 119 to Korean Patent Application Nos. 10-2024-0116817, filed on Aug. 29, 2024, and 10-2024-0153685, filed on Nov. 1, 2024, in the Korean Intellectual Property Office, the disclosures of which are incorporated by reference herein in their entireties.

### BACKGROUND

### 1. Field

The disclosure relates to an aerosol generating device and a method of controlling the aerosol generating device, and more particularly, to a method of controlling heating of a heater by monitoring a temperature of the heater and power supplied to the heater.

### 2. Description of the Related Art

Recently, there has been an increasing demand for an alternative method of overcoming the disadvantages of normal cigarettes. For example, there is an increasing demand for a system for generating aerosols by heating an aerosol generating substrate by using an aerosol generating device, rather than by burning cigarettes. Accordingly, research on heating-type aerosol generating devices has been actively conducted.

However, because the heating-type aerosol generating device is a device that uses high power for a heating operation of a heater, efficient and stable use of a battery is required. Also, precise control of a heating temperature is required to provide a satisfactory smoking feeling to a user.

### SUMMARY

An aerosol generating device may perform feedback control to control heating of a heater to a preset optimal temperature. During a feedback control process, when unnecessary power is consumed or a target temperature is not precisely converged, the efficiency of the aerosol generating device may decrease, and battery stability may deteriorate. Accordingly, a feedback method that enables precise temperature control while ensuring battery efficiency and stability is required. The technical objectives of the disclosure are not limited to the above description, and other technical objectives may be derived from the embodiments described hereinafter.

Additional aspects will be set forth in part in the description which follows and, in part, will be apparent from the description, or may be learned by practice of the presented embodiments of the disclosure.

An aerosol generating device according to the disclosure may achieve power usage efficiency and precise temperature control by performing dual feedback control in which temperature-based feedback control and power-based feedback control are simultaneously performed.

According to an embodiment, an aerosol generating device may include a direct current (DC)/DC converter connected to a battery and configured to output a DC current, a power conversion unit configured to convert the DC current provided from the DC/DC converter into an alternating current (AC) current, a heating unit including an induction coil and a susceptor, the induction coil being configured to generate an alternating magnetic field due to the AC current, and the susceptor being configured to, by being induced by the alternating magnetic field, heat an aerosol generating article inserted into the aerosol generating device, a current sensing unit connected between the DC/DC converter and the power conversion unit and configured to sense the DC current output from the DC/DC converter, and a controller configured to perform temperature monitoring for estimating, based on the sensed DC current, a temperature of the susceptor and power monitoring for estimating, based on the sensed DC current, power supplied from the DC/DC converter to the power conversion unit, and to perform at least one of temperature-based feedback control and power-based feedback control for the DC/DC converter based on results of the temperature monitoring and the power monitoring.

According to another embodiment, a method of controlling an aerosol generating device may include sensing, by a current sensing unit connected between a direct current (DC)/DC converter and a power conversion unit, a DC current, the DC/DC converter being connected to a battery and configured to output the DC current, and the power conversion unit being configured to convert the DC current provided from the DC/DC converter into an alternating current (AC) current, performing, by a controller, temperature monitoring for estimating, based on the sensed DC current, a temperature of a susceptor and power monitoring for estimating, based on the sensed DC current, power supplied from the DC/DC converter to the power conversion unit, and performing, by the controller, at least one of temperature-based feedback control and power-based feedback control for the DC/DC converter based on results of the temperature monitoring and the power monitoring.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an aerosol generating device according to an embodiment;

FIG. 2 illustrates an aerosol generating device according to an embodiment;

FIG. 3 illustrates an aerosol generating device according to another embodiment;

FIG. 4 is a block diagram of an aerosol generating device according to an embodiment;

FIG. 5 is a diagram for explaining a method of performing temperature monitoring and power monitoring for a heating unit, according to an embodiment;

FIG. 6 is a diagram for explaining a temperature profile and a power profile according to an embodiment;

FIG. 7 is a diagram for explaining a method of performing temperature-based feedback control and power-based feedback control, according to an embodiment;

FIG. 8 is a diagram for explaining feedback weights set for each section of a profile, according to an embodiment;

FIGS. 9A and 9B are diagrams for explaining a method of performing temperature-based feedback control and power-based feedback control based on a feedback margin, according to an embodiment; and

FIG. 10 is a flowchart of a method of controlling an aerosol generating device, according to an embodiment.

### DETAILED DESCRIPTION

Hereinafter, embodiments will be described in detail with reference to the accompanying drawings, and the same or similar components will be assigned the same reference numerals regardless of the reference numerals in the drawings, and the same descriptions thereof will be omitted. With regard to the description of the drawings, like reference numerals may be used to represent like or related elements.

The suffixes “module”, “-er”, and “-or” for the components used in the following description are given or used interchangeably by considering only the ease of writing the description, and do not have distinct meanings or roles in themselves. The suffix “module” or “unit”, as used herein, may include a unit implemented as hardware, software, or firmware. For example, the suffix “module” or “unit” may be interchangeably used with the term a “logic”, a “logical block”, a “component”, or a “circuit”. The “module” or “unit” may be an integrally formed component, a minimum unit of the component performing one or more functions, or a part of the minimum unit. For example, the “module” or “unit” may be implemented in the form of an application-specific integrated circuit (ASIC).

In addition, when describing the embodiments of the disclosure, the detailed description of the related known art, which may obscure the subject matter of the embodiments, may be omitted. Also, the accompanying drawings are only intended to facilitate understanding of the embodiments described herein, and the spirit of the disclosure is not limited by the accompanying drawings and should be understood to include all changes, equivalents or alternatives included in the spirit and scope of the disclosure.

Although the terms first, second, etc. may be used herein to describe various elements or components, these elements or components should not be limited by these terms. These terms are only used to distinguish one element or component from another element or component.

When an element is referred to as being “connected to” or “coupled to” another element, it may be directly connected or coupled to the other element or intervening elements may be present. In contrast, when an element is referred to as being “directly connected to” or “directly coupled to”another element, there are no intervening elements present.

The singular forms are intended to include the plural forms as well, unless the context clearly indicates otherwise.

Various embodiments of the present disclosure may be implemented as software including one or more instructions stored in a storage medium (e.g., a memory 17) readable by a machine (e.g., an aerosol generating device 1). For example, a processor (e.g., a controller 12) of the machine (e.g., the aerosol generating device 1) may call at least one instruction among one or more instructions stored from the storage medium and execute the at least one instruction. This makes it possible for the machine to be operated to perform at least one function according to the called at least one instruction. Examples of the one or more instructions may include codes created by a compiler, or codes executable by an interpreter. A machine-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored.

In the present disclosure, a direction of the aerosol generating device 1 may be defined based on an orthogonal coordinate system. The x-axis direction in the orthogonal coordinate system may be defined as a left-right direction of the aerosol generating device 1. The y-axis direction may be defined as a front-back direction of the aerosol generating device 1. The z-axis direction may be defined as an upward and downward direction of the aerosol generating device 1.

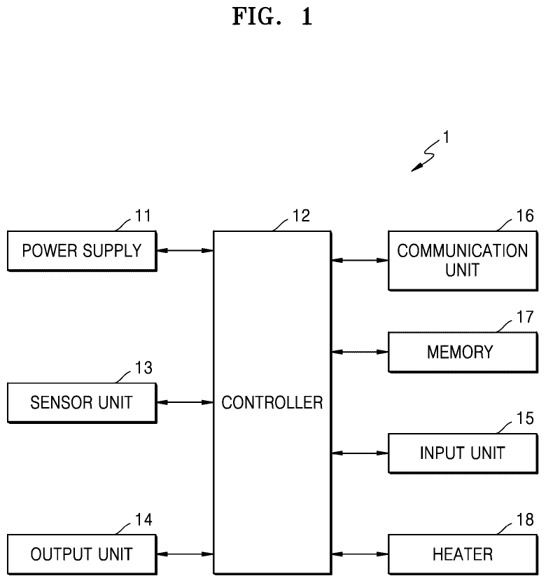

FIG. 1 is a block diagram of the aerosol generating device according to an embodiment.

According to an embodiment, the aerosol generating device 1 may include a power supply 11, the controller 12, a sensor unit 13, an output unit 14, an input unit 15, a communication unit 16, a memory 17, and/or heater 18. However, it may be understood by those skilled in the art that some of the components shown in FIG. 1 may be omitted or new components may be added, according to the design of the aerosol generating device 1.

According to an embodiment, the sensor unit 13 may sense a state of the aerosol generating device 1 or a state of the surroundings of the aerosol generating device 1 and may transmit information corresponding to the sensed state to the controller 12. For example, the sensor unit 13 may include a temperature sensor, a puff sensor, an insertion detection sensor, a reuse detection sensor, an overwetting detection sensor, a cigarette identification sensor, a cartridge detection sensor, a cap detection sensor, and/or a movement detection sensor. The sensor unit 13 may further include various sensors, such as a liquid remaining amount sensor for detecting the liquid remaining amount of a cartridge and an immersion sensor for detecting immersion of the aerosol generating device 1.

According to an embodiment, the temperature sensor may sense a temperature to which the heater 18 is heated. The aerosol generating device 1 may include a separate temperature sensor that directly senses a temperature of the heater 18, or the temperature may be indirectly estimated from a value measured by the temperature sensor (e.g., a current). For example, the temperature sensor may measure a current and/or voltage applied to the heater 18 (or an induction coil). The controller 12 may calculate the temperature for the heater 18 based on the measured current and/or voltage.

According to an embodiment, the temperature sensor may detect a temperature of the power supply 11. The temperature sensor may be disposed adjacent to the power supply 11. For example, the temperature sensor may be attached to one surface of the power supply 11 (e.g., a battery) and/or mounted on one surface of a printed circuit board. For example, the aerosol generating device 1 may include a power protection circuit module (PCM), and the temperature sensor may be disposed adjacent to the power supply 11 together with the power PCM.

According to an embodiment, the temperature sensor may be disposed inside a housing (not shown) of the aerosol generating device 1 to detect an internal temperature of the housing.

According to an embodiment, the puff sensor may detect a puff of a user.

For example, the puff sensor may include a pressure sensor. The pressure sensor may output a signal corresponding to an internal pressure of the aerosol generating device 1, and the controller 12 may detect the puff of the user, based on the signal corresponding to the internal pressure. The internal pressure of the aerosol generating device 1 may correspond to pressure of an airflow path along which gas flows. The puff sensor may be disposed to correspond to the airflow path along which gas flows, in the aerosol generating device 1.

As another example, the puff sensor may include a temperature sensor. When the user′ puff occurs, a temporary temperature drop may occur in the airflow path, a space where an aerosol generating article is inserted (hereinafter, an insertion space), the heater 18, etc. The controller 12 may detect the user's puff, based on a signal corresponding to the temperature of the airflow path, etc. output from the temperature sensor.

As another example, the puff sensor may include both a pressure sensor and a temperature sensor. In this case, the temperature sensor may measure a temperature that is used to correct an internal pressure measured by the pressure sensor. For example, the puff sensor may correct the signal corresponding to the internal pressure, based on the temperature measured by the temperature sensor, and may output the corrected signal. As another example, the puff sensor may output the signal corresponding to the temperature measured by the temperature sensor, and the signal corresponding to the internal pressure measured by the puff sensor. In this case, the controller 12 may receive the signals, and may correct the signal corresponding to the internal pressure, based on the signal corresponding to the temperature.

As another example, the puff sensor may include a capacitance sensor. In the present disclosure, the capacitance sensor may also be referred to as a cap sensor or a capacitive sensor. When the user's puff occurs, a temperature change and/or aerosol flow may occur within the insertion space of the aerosol generating article, and accordingly, an internal permittivity of the insertion space may change. The controller 12 may detect the user's puff, based on a signal corresponding to the internal permittivity, etc. of the insertion space output by the temperature sensor.

The puff sensor is not limited to the aforementioned examples, and may be implemented using various sensors for detecting the user's puff.

According to an embodiment, the insertion detection sensor may detect insertion and/or removal of the aerosol generating article. The insertion detection sensor may be provided around the insertion space. The insertion detection sensor may also include any combination of the aforementioned examples.

For example, the insertion detection sensor may include a capacitance sensor. The capacitance sensor may include at least one conductor. The at least one conductor may be arranged adjacent to the insertion space. When the aerosol generating article is inserted into or removed from the insertion space, a permittivity around the conductor may change. The controller 12 may detect the insertion and/or removal of the aerosol generating article, based on a signal corresponding to the internal permittivity, etc. of the insertion space output by the capacitance sensor.

As another example, the insertion detection sensor may include an inductive sensor. The inductive sensor may include at least one coil. The at least one coil may be disposed adjacent to the insertion space. When the aerosol generating article (e.g., a wrapper of the aerosol-generating article) includes a conductor and is inserted into or removed from the insertion space, a change in a magnetic field may occur around a coil where a current flows. The controller 12 may detect insertion and/or removal of the aerosol generating article including the conductor, based on the characteristics (e.g., a frequency, a current value, a voltage value, an inductance value, and an impedance value of an alternating current (AC) current) of a current output or detected by the inductive sensor. Alternatively, the aerosol generating article (e.g., a medium portion of the aerosol generating article) may include a susceptor (SUS), etc. Even in this case, a change in the magnetic field around the coil may occur based on the insertion or removal of the susceptor, etc. within the insertion space, and the controller 12 may also detect the insertion and/or removal of the aerosol generating article, based on the characteristics of the current of the inductive sensor.

The insertion detection sensor is not limited to the aforementioned examples, and may be implemented using any of various sensors (e.g., a proximity sensor) for detecting insertion and/or removal of the aerosol generating article. The insertion detection sensor may also include any combination of the aforementioned examples. According to an embodiment, the insertion detection sensor may include a switch, etc. for detecting compression performed by the aerosol generating article.

According to an embodiment, the reuse detection sensor may detect whether the aerosol generating article is reused For example, the reuse detection sensor may be a color sensor for detecting a color of the aerosol generating article. When the aerosol generating article is used by the user, a change in the color of a portion of the wrapper surrounding the outside of the aerosol generating article may occur due to generated aerosol or heating. The color sensor may output a signal corresponding to optical characteristics (e.g., a wavelength of light) corresponding to the color of the wrapper, based on light reflected by the wrapper. When a change in the color of the portion of the wrapper is detected, the controller 12 may determine that the aerosol generating article inserted into the insertion space has already been used.

According to an embodiment, the overwetting detection sensor may detect whether the aerosol generating article is in an overwetting state. For example, the overwetting detection sensor may include a capacitance sensor. The capacitance sensor may include at least one conductor disposed adjacent to the insertion space. The controller 12 may detect whether the aerosol generating article is in an overwetting state, based on the level of a signal corresponding to a permittivity, etc. output by the capacitance sensor. For example, the controller 12 may check a level range including the level of the signal, based on a look-up table, and may determine a moisture content for the aerosol generating article, based on the checked level range.

According to an embodiment, the cigarette identification sensor may detect whether the aerosol generating article is authentic, and/or detect the type of the aerosol generating article.

For example, the cigarette identification sensor may include an optical sensor for detecting an identification material (or an identification mark) located on an outer surface (e.g., a wrapper) of the aerosol generating article. The optical sensor may radiate light toward the identification material (or the identification mark) of the aerosol generating article, and may detect the authenticity and/or the type of the aerosol generating article, based on the reflected light. For example, the identification material may include a material that emits light of a wavelength in a specific band, based on the radiated light. The controller 12 may detect the authenticity and/or the type of the aerosol generating article, based on the range of the wavelength.

As another example, the cigarette identification sensor may include a capacitance sensor. According to the types of aerosol generating article inserted into the insertion space, the internal permittivity of the insertion space may vary. The controller 12 may detect he authenticity of and/or the type of the aerosol generating article, based on the signal corresponding to the internal permittivity, etc. of the insertion space output by the capacitance sensor.

As another example, the cigarette identification sensor may include an inductive sensor. When a conductor is included in the wrapper and/or interior (e.g., a medium portion) of the aerosol generating article inserted into the insertion space, the characteristics of a current detected by the inductive sensor (e.g., a frequency, a current value, a voltage value, an inductance value, and an impedance value of an AC current) may differ according to the types of aerosol generating article inserted into the insertion space. The controller 12 may detect the authenticity of and/or the type of the aerosol generating article, based on the characteristics of a current output by the capacitance sensor or detected by the inductive sensor.

The cigarette identification sensor is not limited to the aforementioned examples, and may be implemented using any of various sensors for detecting whether the aerosol generating article is authentic, and/or detecting the type of the aerosol generating article. The cigarette identification sensor may also include any combination of the aforementioned examples.

According to an embodiment, the cartridge detection sensor may detect insertion and/or removal of the cartridge. For example, the cartridge detection sensor may include an inductive sensor, a capacitance sensor, a resistance sensor, a hall sensor (a hall IC) using a hall effect, and/or an optical sensor.

According to an embodiment, the cap detection sensor may detect insertion and/or removal of the cap. For example, the cap detection sensor may include an inductive sensor, a capacitance sensor, a resistance sensor, a hall sensor (a hall IC), and/or an optical sensor. The cap may include a structure that covers at least a portion of the cartridge mounted on or inserted into the aerosol generating device 1 or covers at least a portion of the housing of the aerosol generating device 1. When the cap is mounted on or removed from the housing, the cap detection sensor may output a signal corresponding to the mounting or removal of the cap. The controller 12 may detect the mounting or removal of the cap, based on a signal corresponding to the mounting or removal.

According to an embodiment, the movement detection sensor may detect a motion of the aerosol generating device 1. The movement detection sensor may be implemented using at least one of an acceleration sensor and a gyro sensor.

According to an embodiment, the sensor unit 13 may further include at least one of a humidity sensor, a pressure sensor, a magnetic sensor, a global positioning sensor (GPS), or a proximity sensor, in addition to the above-described sensors. Functions of the sensors would be instinctively understood by one of ordinary skill in the art in view of their names and thus detailed descriptions thereof will be omitted herein.

According to an embodiment, the output unit 14 may output information about the state of the aerosol generating device 1. The output unit 14 may include a display, a haptic unit, and/or a sound output unit, but embodiments are not limited thereto. For example, information about the aerosol generating device 1 may include a charging/discharging state of the power supply 11 of the aerosol generating device 1, preheating states of the heater 18, an insertion/removal state of the aerosol generating article and/or the cartridge, a mounting and/or removal state of the cap, or a state in which use of the aerosol generating device 1 is limited (e.g., detection of an abnormal article). The display may visually provide the information about the state of the aerosol generating device 1 to the user. For example, the display may include a light-emitting diode (LED), a liquid crystal display (LCD), an organic light-emitting diode (OLED), etc. When the display includes a touch pad, the display may also be used as an input unit 15. A haptic unit may tactually provide the information about the state of the aerosol generating device 1 to the user. For example, the haptic unit may include a vibration motor, a piezoelectric element, an electrical stimulation device, etc. The sound output unit may acoustically provide the information about the aerosol generating device 1 to the user. For example, the sound output unit may convert an electrical signal into a sound signal and may output the sound signal to the outside.

According to an embodiment, the power supply 11 may output power for operating the aerosol generating device 1. The power supply 11 may include one or more batteries. The power supply 11 may supply power so that the heater 18 may be heated. In addition, the power supply 11 may supply power required for operations of the controller 12, the sensor unit 13, the output unit 14, the input unit 15, the communication unit 16, the memory 17, etc. which are other components included in the aerosol generating device 1. The power supply 11 may be a rechargeable battery or a disposable battery. For example, the power supply 11 may be a lithium polymer (LiPoly) battery, but embodiments are not limited thereto. The power supply 11 may be a rechargeable (separate-type) battery (hereinafter, a detachable battery. The detachable battery may be mounted on a battery accommodation part provided within the aerosol generating device 1, or may be removed from the battery accommodation part. The detachable battery may be charged either via wire or wirelessly.

According to an embodiment, the heater 18 may heat a medium and/or an aerosol generating material within the aerosol generating article and/or the cartridge by receiving power from the power supply 11. The aerosol generating device 1 may include a heater 18 for heating the aerosol generating article and/or a cartridge heater 24 for heating the cartridge (i.e., a solid and/or liquid medium).

According to an embodiment, the heater 18 may be electro-resistive heaters. For example, the electro-resistive heaters may include an electro-resistive material, such as a metal including titanium, zirconium, tantalum, platinum, nickel, cobalt, chromium, hafnium, niobium, molybdenum, tungsten, tin, gallium, manganese, iron, copper, stainless steel, nichrome, or the like, or a metal alloy. The electro-resistive heaters may be implemented using a metal heating wire, a metal heating plate on which an electric conductive track is disposed, a ceramic heating body, or the like.

According to an embodiment, the heater 18 may be induction heating heaters. For example, the induction heating heaters may include a susceptor that generates heat through a magnetic field. The magnetic field may be generated from an induction coil by an AC current flowing through the induction coil. The generated magnetic field may penetrates a heater and an eddy current may be generated by the susceptor. The susceptor may be heated based on the generation of the eddy current. According to an embodiment, the susceptor may be included within the aerosol generating article (e.g., the medium portion). Even in this case, the susceptor included within the aerosol generating article may be heated by the induction coil.

The heater 18 are not limited to the aforementioned examples, and may include or be replaced with various heating methods, structures, components, etc. for heating the aerosol generating article and/or the cartridge.

According to an embodiment, the input unit 15 may receive information input by the user. For example, the input unit 15 may include a touch panel, a button, a keypad, a dome switch, a jog wheel, a jog switch, etc.

According to an embodiment, the memory 17 is hardware for storing various kinds of data processed in the aerosol generating device 1, and may store pieces of data that have been processed and are to be processed by the controller 12. For example, the memory 17 may include at least one type of storage medium selected from among a flash memory type, a hard disk type, a multimedia card micro type, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), magnetic memory, a magnetic disk, and an optical disk. For example, the memory 17 may store data about an operating time of the aerosol generating device 1, a maximum number of puffs, a current number of puffs, at least one temperature profile, and the user's smoking pattern.

According to an embodiment, the communication unit 16 may include at least one component for communication with another electronic device (e.g., a portable electronic apparatus). For example, the communication unit 16 may include a Bluetooth communication unit, a Bluetooth Low Energy (BLE) communication unit, an Near Field Communication (NFC) communication unit, a wireless local area network (WLAN) communication unit, a ZigBee communication unit, an infrared Data Association (IrDA) communication unit, a Wireless Fidelity Direct (WFD) communication unit, an ultra wideband (UWB) communication unit, an Adaptive Network Topology (Ant)+ communication unit, a cellular network communication unit, an Internet communication unit, a computer network (e.g., a LAN or WAN) communication unit, etc.

According to an embodiment, the controller 12 may control overall operations of the aerosol generating device 1. For example, the controller 12 may include at least one processor. The controller 12 may be implemented as an array of a plurality of logic gates, or as a combination of a general-use micro controller unit (MCU) (or a microprocessor) and a memory in which a program executable by the general-use MCU is stored. It will also be understood by one of ordinary skill in the art to which the present embodiment pertains that the controller 12 may be implemented as other types of hardware.

According to an embodiment, the controller 12 may control supplying of the power of the power supply 11 to the heater 18, thereby controlling the temperatures of the heater 18. The controller 12 may control the temperatures of the heater 18 and/or power supplied to the heater 18, based on the temperatures of the heater 18 detected using the temperature sensor (e.g., the sensor unit 13). The controller 12 may control the temperatures of the heater 18 and/or the power supplied to the heater 18, based on a temperature profile and/or a power profile stored in the memory 17.

According to an embodiment, the controller 12 may control power (e.g., a voltage and/or a current) supplied to the heater 18 by controlling a power conversion circuit (not shown) electrically connected to the heater 18 and the power supply 11. For example, the power conversion circuit may include a DC/DC converter (e.g., a buck converter, a buck-boost converter, a boost converter, or a Zener diode) that converts power that is to be supplied to the heater 18, and a DC/AC converter (e.g., an inverter) that converts power that is to be supplied to an induction coil (not shown). The DC/AC inverter may be implemented as a full-bridge circuit or half-bridge circuit including a plurality of switching elements. For example, the power conversion circuit may include at least one switching element, such as a bipolar junction transistor (BJT) and a field effect transistor (FET).

According to an embodiment, the controller 12 may control the current and/or voltage supplied to the heater 18 by controlling the frequency and/or duty ratio of a current pulse input to the at least one switching element of the power conversion circuit. A duty ratio with respect to an on/off operation of the switching element may correspond to a ratio of an output voltage of the power conversion circuit to an output voltage of the power supply 11.

According to an embodiment, the controller 12 may control power that is supplied to the heater 18, by using at least one method among a pulse width modulation (PWM) method and a proportional-integral-differential (PID) method. For example, the controller 12 may control a current pulse having a certain frequency and a duty ratio to be supplied to the heater 18, by using the PWM method. The controller 12 may control the power supplied to the heater 18, by adjusting the frequency and duty ratio of the current pulse. For example, the controller 12 may determine a target temperature that is a target of control, based on the temperature profile. The controller 12 may control the power supplied to the heater 18, by using a PID method, which is a feedback control method using a difference value between the temperatures of the heater 18 and the target temperature thereof, a value obtained by integrating the difference value according to the flow of time, and a value obtained by differentiating the difference value according to the flow of time.

According to an embodiment, the controller 12 may determine target power that is a target of control, based on the power profile. The controller 12 may control the power supplied to the heater 18 to correspond to preset target power, according to the flow of time.

According to an embodiment, the controller 12 may detect the user's puff by detecting the power supplied to the heater 18. In more detail, the controller 12 may control the power supplied to the heater 18, by using the PID method. When the user′ puff occurs, a temporary temperature drop may occur in a space where the aerosol generating article is inserted (hereinafter, the insertion space), the heater 18, etc. Accordingly, a change may occur in the power (or current) supplied to the heater 18 during power control using the PID method. The controller 12 may detect the user's puff, based on a change in the power that is controlled.

According to an embodiment, the controller 12 may prevent the heater 18 from being heated. For example, the controller 12 may control an operation of the power conversion circuit so that the amount of the power supplied to the heater 18 is reduced or the power supply to the heater 18 is stopped, based on the temperatures of the heater 18 exceeding a preset limit temperature.

According to an embodiment, the controller 12 may control charging/discharging of the power supply 11. For example, the controller 12 may check the temperature of the power supply 11 by using the temperature sensor (e.g., the sensor unit 13). When the temperature of the power supply 11 is equal to or greater than a first limit temperature, the controller 12 may block charging of the power supply 11. When the temperature of the power supply 11 is greater than or equal to a second limit temperature, the controller 12 may stop using (e.g., discharging) the power stored in the power supply 11. The controller 12 may calculate the remaining capacity of the power stored in the power supply 11. For example, the controller 12 may calculate the remaining capacity of the power supply 11, based on a voltage and/or current sensing value of the power supply 11.

According to an embodiment, the controller 12 may control supply of power to the heater 18, based on a result of the sensing performed by the sensor 13.

According to an embodiment, the controller 12 may control supply of power to the heater 18, based on insertion and/or removal of the aerosol generating article into and/or the insertion space. For example, when it is determined using the insertion detection sensor (e.g., the sensor unit 13) that the aerosol generating article has been inserted into the insertion space, the controller 12 may control power to be supplied to the heater 18. When it is determined using the insertion detection sensor (e.g., the sensor unit 13) that the aerosol generating article has been removed from the insertion space, the controller 12 may block the supply of power to the heater 18. When the temperatures of the heater 18 are equal to or greater than a limit temperature or temperature change slopes of the heater 18 are equal to or greater than a set slope, the controller 12 may determine that the aerosol generating article has been removed from the insertion space.

According to an embodiment, the controller 12 may control power supply time periods and/or power supply amounts for the heater 18, based on the state of the aerosol generating article. For example, when it is determined using the overwetting detection sensor (e.g., the sensor unit 13) that the aerosol generating article is in an overwetting state, the controller 12 may increase the power supply time periods (e.g., preheating time periods) for the heater 18.

According to an embodiment, the controller 12 may control supply of power to the heater 18, based on reuse or non-reuse of the aerosol generating article. For example, when it is determined that the aerosol generating article has been used, the controller 12 may block supply of power to the heater 18.

According to an embodiment, the controller 12 may control supply of power to the heater 18, based on attachment and/or removal of the cartridge. For example, when it is determined using the cartridge detection sensor (e.g., the sensor unit 13) that the cartridge is in a separated state, the controller 12 may block supply of power to the heater 18 or may control power to be not supplied to the heater 18.

According to an embodiment, the controller 12 may control supply of power to the heater 18, based on whether the aerosol generating material of the cartridge has been exhausted. For example, when it is determined that the temperatures of the heater 18 exceed the limit temperature while the heater 18 are being preheated (i.e., in a preheating section), the controller 12 may determine that the aerosol generating material in the cartridge has been exhausted. When it is determined that the aerosol generating material of the cartridge has been exhausted, the controller 12 may cut off the supply of power to the heater 18.

According to an embodiment, the controller 12 may control the supply of power to the heater 18, based on whether use of the cartridge is possible. For example, when it is determined based on data stored in the memory 17 that a current number of puffs is equal to or greater than a maximum number of puffs set in the cartridge, the controller 12 may determine that the use of the cartridge is not possible. For example, when a total time period during which the heater 18 are heated is greater than or equal to a preset maximum time period or a total amount of power supplied to the heater 18 is greater than or equal to a preset maximum power amount, the controller 12 may determine that the use of the cartridge is not possible. In this case, the controller 12 may block supply of power to the heater 18 or may control power to be not supplied to the heater 18.

According to an embodiment, the controller 12 may control the supply of power to the heater 18, based on the user's puff. For example, the controller 12 may determine occurrence or non-occurrence of a puff and/or the intensity of the puff, by using the puff sensor (e.g., the sensor unit 13). When the number of puffs reaches the preset maximum of puffs or puffs are not sensed for a preset time period or more, the controller 12 may cut off the supply of power to the heater 18. When a puff is sensed, the controller 12 may control the supply of power to the heater 18.

According to an embodiment, the controller 12 may control supply of power to the heater 18, based on authenticity of the aerosol generating article (or the cartridge) and/or the type of the aerosol generating article. For example, the controller 12 may detect authenticity or of the aerosol generating article and/or the type of the aerosol generating article, by using the cigarette identification sensor (e.g., the sensor unit 13). For example, when the aerosol generating article (or the cartridge) is detected as counterfeit, the controller 12 may block supply of power to the heater 18. When the aerosol generating article (or the cartridge) is detected as authentic, the controller 12 may control (e.g., start) supply of power to the heater 18. As another example, the controller 12 may differently control power supply to the heater 18 according to the types of aerosol generating article (or cartridge). In more detail, when the aerosol generating article (or the cartridge) is detected as a first aerosol generating article (or a first cartridge), the controller 12 may control the temperatures and/or power of the heater 18, based on a first temperature profile (or a first power profile), and, when the aerosol generating article (or cartridge) is detected as a second aerosol generating article (or a second cartridge), may control the temperatures and/or power of the heater 18, based on a second temperature profile (or a second power profile).

According to an embodiment, the controller 12 may control the output unit 14, based on a result of the sensing performed by the sensor unit 13. For example, when the number of puffs counted using the puff sensor (e.g., the sensor unit 13) reaches a preset number, the controller 12 may control the output unit 14 to visually, tactually, and/or acoustically provide information indicating that the aerosol generating device 1 is about to be terminated. For example, the controller 12 may control the output unit 14 to visually, tactually, and/or acoustically provide information about the temperatures of the heater 18.

According to an embodiment, the controller 12 may store and update a history of an event occurred in the memory 17, based on certain event occurrence. For example, the event may include insertion detection of the aerosol generating article, heating start of the aerosol generating article, puff detection, puff end, overheat detection of the heater 18, detection of overvoltage application to the heater 18, heating end of the aerosol generating article, an operation such as power on/off of the aerosol generation device 1, charging start of the power supply 11, detection of overcharging of the power supply 11, and charging end of the power supply 11, which are performed by the aerosol generating device 1. For example, the history of the event may include, for example, a date and time of the event, and log data corresponding to the event. For example, when a predetermined event is insertion detection of the aerosol generating article, log data corresponding to the event may include data for a sensing value, etc. of the insertion detection sensor (e.g., the sensor unit 13). For example, when the predetermined event is overheating detection of the heater 18, the log data corresponding to the event may include data about, for example, the temperature of the heater 18, the voltage applied to the heater 18, and the current flowing through the heater 18.

According to an embodiment, the controller 12 may control the communication unit 16 to form a communication link with an external device, such as the user's mobile terminal.

According to an embodiment, when receiving data on authentication from the external device through the communication link, the controller 12 may dismiss limitation of the use of at least one function (e.g., a heating function) of the aerosol generating device 1. For example, the data on authentication may include the user's birthday, a unique number representing the user, and completion or non-completion of authentication of the user.

According to an embodiment, the controller 12 may transmit data on the state of the aerosol generating device 1 (e.g., a remaining capacity of the power supply 11, and an operating mode) to the external device via the communication link. The transmitted data may be output through, for example, a display of the external device.

According to an embodiment, when a request for a location search of the aerosol generating device 1 is received from the external device via the communication link, the controller 12 may control the communication unit 16 to perform an operation corresponding to the location search. For example, the controller 12 may control the haptic unit to generate vibration, or may control the display to output an object corresponding to the location search and a search end.

According to an embodiment, when receiving firmware data from the external device via the communication link, the controller 12 may perform firmware update.

According to an embodiment, the controller 12 may transmit data on a sensing value of at least one sensor unit 13 to an external server (not shown) through the communication link, and may receive and store a learning model generated by learning sensing values from a server through machine learning, such as deep learning. The controller 12 may perform, for example, an operation of determining the user's inhaling pattern and an operation of generating a temperature profile, by using the learning model received from the server.

Although not shown in FIG. 1, the aerosol generating device 1 may further include a power supply protection circuit. The power protection circuit may include at least one switching element, and may cut off transmission path to the power supply 11 in response to overcharging and/or overdischarging of the power supply 11. The aerosol generating device 1 may further include a connection interface, such as a universal serial bus (USB) interface, and may transmit/receive information by being connected to another external device through the connection interface, or may charge the power supply 11.

The aerosol generating article as described herein may include at least one aerosol generating rod (e.g., a medium portion) and at least one filter rod. The heater 18 may be arranged to correspond to the at least one aerosol generating rod, and may be designed differently according to arrangement orders and/or locations of the aerosol generating rod and the filter rod. The aerosol generating rod may include at least one of nicotine, an aerosol generating material, and additives. For example, the aerosol generating material may include glycerin (e.g., vegetable glycerin (VG)) and/or propylene glycol (PG), but may also include various other materials. For example, the additives may include flavors and/or organic acid, and may also include various other materials. For example, the aerosol generating rod may include an aerosol generating substrate (e.g., a sheet) impregnated with a liquid non-tobacco material (e.g., an aerosol generating material and/or nicotine), and/or may include a solid tobacco material (e.g., leaf tobacco and reconstituted tobacco). The tobacco material may be included in the aerosol generating rod in various forms, such as Cut Tobacco, granules, or powder. According to an embodiment, the additives of the aerosol generating rod may include an alkaline substance. Based on the basic material, the nicotine of the tobacco material included in the aerosol generating rod may have an alkaline pH (e.g., pH 7.0 or higher). In this case, freebase nicotine may be released from the aerosol generating rod even at low temperature. According to an embodiment, the aerosol generating rod may include two or more aerosol generating rods, wherein the two or more aerosol generating rods may include a tobacco material and/or a non-tobacco material, respectively. Although not shown, at least one aerosol generating rod and at least one filter rod may be individually and/or integrally wrapped by at least one wrapper. In the disclosure, the aerosol generating article may be referred to as a stick.

The cartridge mentioned in the disclosure may contain an aerosol generating material in any one state among a liquid state, a solid state, a gaseous state, a gel state, and the like. The aerosol generating material may include a liquid composition. For example, the liquid composition may be a liquid including a tobacco-containing material having a volatile tobacco flavor component, or may be a liquid including a non-tobacco material. The cartridge may include a storage containing an aerosol generating material and/or a liquid delivery unit impregnated with (containing) the aerosol-generating material. For example, the liquid delivery unit may include a wick or the like, such as a cotton fiber, a ceramic fiber, a glass fiber, or porous ceramic. The cartridge heater 24 may be included in the cartridge, as a coil-shaped structure that is wound around the liquid delivery unit or in a structure in contact with one side of the liquid delivery unit. Alternatively, the cartridge heater 24 may be included in an aerosol generating device 1 that is separable from the cartridge.

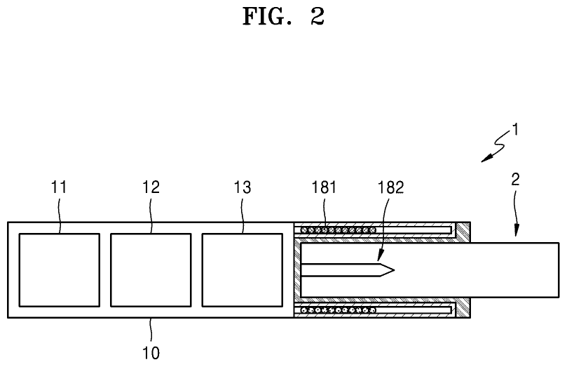

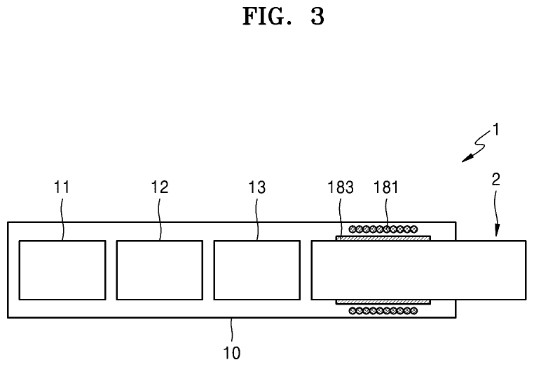

FIG. 2 illustrates an aerosol generating device according to an embodiment. FIG. 3 illustrates an aerosol generating device according to another embodiment.

According to an embodiment, the aerosol generating device 1 may include a housing 10, the power supply 11, the controller 12, the sensor unit 13, and/or a heater 182 or 183 (e.g., the heater 18 of FIG. 1). However, the components included in the aerosol generating device 1 are not limited to those shown in FIG. 2 or 3. It may be understood by those skilled in the art that some of the components shown in FIG. 2 or 3 may be omitted or new components may be added. The aerosol generating device 1 illustrated in FIG. 2 may be referred to as an ‘internal heating type’ aerosol generating device that heats the inside of an aerosol generating article 2. The aerosol generating device 1 illustrated in FIG. 3 may be referred to as an ‘external heating type’ aerosol generating device that heats the outside of the aerosol generating article 2. In the drawings below, any description that overlaps with FIG. 1 will be omitted.

According to an embodiment, the housing 10 may provide a space opened upward so that the aerosol generating article 2 may be inserted. In the disclosure, the upwardly-opened space may be referred to as an insertion space. The insertion space may be recessed toward the inside of the body 10 by a certain depth so that at least a portion of the aerosol generating article 2 may be inserted thereinto. The depth of the insertion space may be equal to or greater than a length of a region in the aerosol generating article 2, in which an aerosol generating material and/or a medium is included. A lower end of the aerosol generating article 2 may be inserted into the housing 10, and an upper end of the aerosol generating article 2 may protrude to the outside of the housing 10. A user may inhale aerosol by holding, in his or her mouth, the upper end of the aerosol generating article 2 exposed to the outside.

According to an embodiment, the heaters 182 and 183 may heat the aerosol generating article 2.

Referring to FIG. 2, the heater 182 may be implemented as an internal heating heater.

According to an embodiment, the internal heating heater may extend long upward in a space (i.e., the insertion space) into which the aerosol generating article 2 is inserted. As illustrated in FIG. 2, the internal heating heater may include a rod-shaped heating element or a needle-shaped heating element. However, the internal heating heater may include any of various heating elements, such as a tube-shaped heating element or a plate-shaped heating element. The internal heating heater may be inserted through a lower side of the aerosol generating article 2.

According to an embodiment, the internal heating heater may include an electrically resistive heater and/or an induction heating heater.

For example, in the case of induction heating heaters, the aerosol generating device 1 may include the induction coil 181 surrounding at least a portion of the internal heating heater (e.g., being positioned outside to correspond to a length of at least a portion of the heater). In this case, a magnetic flux concentrator, etc. may be further included on the outside of the induction coil 181 in order to increase the efficiency of induction heating. An induction heating heater may include a susceptor, and may generate heat based on a magnetic field generated by the induction coil 181. According to an embodiment, the induction heating heater (e.g., a susceptor) (or a heater module including the induction heating heater) may be arranged to be detachable from the housing 10.

For example, the electrically resistive heater may include an electrically resistive material on the inside (e.g., an inner hollow or an inner surface) or the outside (e.g., an outer surface), and may be heated as a current flows through the electrically resistive material. In this case, the electrically resistive heater may be electrically connected to the power supply 11, and may directly generate heat by receiving a current from the power supply 11. An induction coil 181 may be omitted.

According to an embodiment, the heater 181 may be multiple heaters. The multiple heaters may include a first heater and a second heater, and may be inserted into the aerosol generating article 2. The first heater and the second heater may be arranged in parallel to each other in a longitudinal direction. The first heater and the second heater may operate as electrically resistive heaters and/or induction heating heaters, and may be sequentially heated or may be simultaneously heated. In this case, the first heater and the second heater may be respectively arranged at locations corresponding to longitudinal locations of two or more aerosol generating rods. Alternatively, the first heater and the second heater may be respectively arranged at locations corresponding to longitudinal locations of a first portion and a second portion of one aerosol generating rod. When the heater 182 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 182. Three or more heaters and/or three or more induction coils may be included.

According to an embodiment, a susceptor may be disposed (or included) in the inside (e.g., the medium portion) of the aerosol generating article 2, and the susceptor included within the aerosol generating article 2 may be implemented to generate heat, based on the magnetic field generated by the induction coil 181.

Referring to FIG. 3, the heater 183 may be an external heating heater.

According to an embodiment, the external heating heater may extend long upward around a space (i.e., the insertion space) into which the aerosol generating article 2 is inserted. For example, the external heating heater may be disposed to surround at least a portion of the insertion space. For example, the external heating heater may include a tubular shape (e.g., a cylindrical shape) including a hollow therein. The external heating heater may have a shape including a hollow on the inside and surrounding the hollow. In this case, the external heating heater may be supported by a polyimide film. A heater supported by such a film may be referred to as a film heater. The external heating heater may be disposed to surround at least a portion of the insertion space. The external heating heater may heat the outside of the aerosol generating article 2 inserted into the hollow.

According to an embodiment, the external heating heater may include an electrically resistive heater and/or an induction heating heater. A description of FIG. 3 that overlaps with FIG. 2 will be omitted. In the case of induction heating heaters, the aerosol generating device 1 may include an external heating heater implemented as a tube-shaped susceptor, and may include the induction coil 181 surrounding at least a portion of the external heating heater (e.g., being positioned outside to correspond to a length of at least a portion of the heater). The induction coil 181 may include a fan coil. When the external heating heater is an electrically resistive heater, heat generation is possible through a current flow on a tube-shaped electrically resistive heater (e.g., a film heater), and thus the separate induction coil 181 may be omitted. Insulation may also be disposed on the outside of the external heating heater. Accordingly, the heat radiated outward by the heater 183 and applied to the outside of the housing 10 may be reduced.

According to one embodiment, the heater 183 may be multiple heaters, and the first heater and the second heater may be arranged side by side along the longitudinal direction so as to each surround at least a portion of the insertion space. The first heater and the second heater may operate as electrically resistive heaters and/or induction heating heaters, and may be sequentially heated or may be simultaneously heated. When the heater 183 is an induction heating heater, the aerosol generating device 1 may include a first induction coil and a second induction coil, and the first induction coil and the second induction coil may be respectively arranged at locations corresponding to longitudinal locations of the first heater and the second heater. Alternatively, the first heater and the second heater may be respectively arranged at locations corresponding to longitudinal locations of a first portion and a second portion of the one heater 183.

Unlike what shown in FIG. 2 or FIG. 3, the heater 182 of FIG. 2 and the heater 183 of FIG. 3 may be included together in the aerosol generating device 1. In this case, the heater 182 may heat the inside of the aerosol generating article 2, and the heater 183 may heat the outside of the aerosol generating article 2.

According to an embodiment, the aerosol generating device 1 may be provided with an airflow channel through which air flows. For example, the housing 10 may include a structure (e.g., a hole) in which air may be introduced from the outside into the housing 10. The air introduced into the housing 10 may be introduced into the aerosol generating article 2 through the lower end (i.e., an upstream side) of the aerosol generating article 2. Aerosol generated based on the heating of the aerosol generating article 2, together with the introduced air, may be inhaled into the user's mouth through the upper end (i.e., the downstream side) of the aerosol generating article 2.

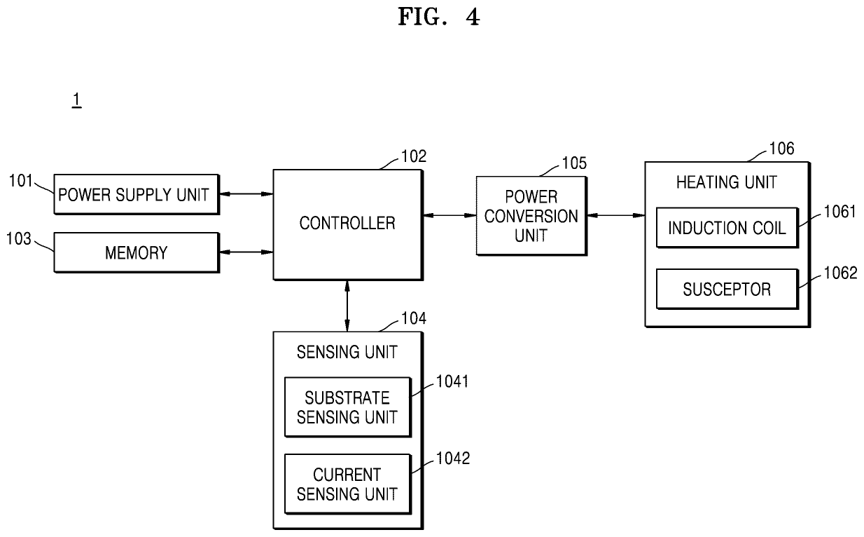

FIG. 4 is a block diagram of an aerosol generating device according to an embodiment.

Referring to FIG. 4, the aerosol generating device 1 may include a power supply unit 101, a controller 102, a sensing unit 104, a memory 103, a power conversion unit 105, and a heating unit 106. The sensing unit 104 may include a substrate sensing unit 1041 and a current sensing unit 1042, and the heating unit 106 may include an induction coil 1061 and a susceptor 1062. The aerosol generating device 1 of FIG. 4 mainly shows components related to embodiments for feedback control to be described below. Regarding components not shown in the aerosol generating device 1 of FIG. 4, the components included in the aerosol generating device 1 described with reference to FIGS. 1 to 3 may also be included in the aerosol generating device 1 of FIG. 4. The components of the aerosol generating device 1 that are commonly shown in FIGS. 1 to 4 may be corresponding components.

The power supply unit 101 may supply power to be used for the aerosol generating device 1 to operate. For example, the power supply unit 101 may supply power to at least one of the controller 102, the sensing unit 104, the memory 103, the power conversion unit 105, and the heating unit 106.

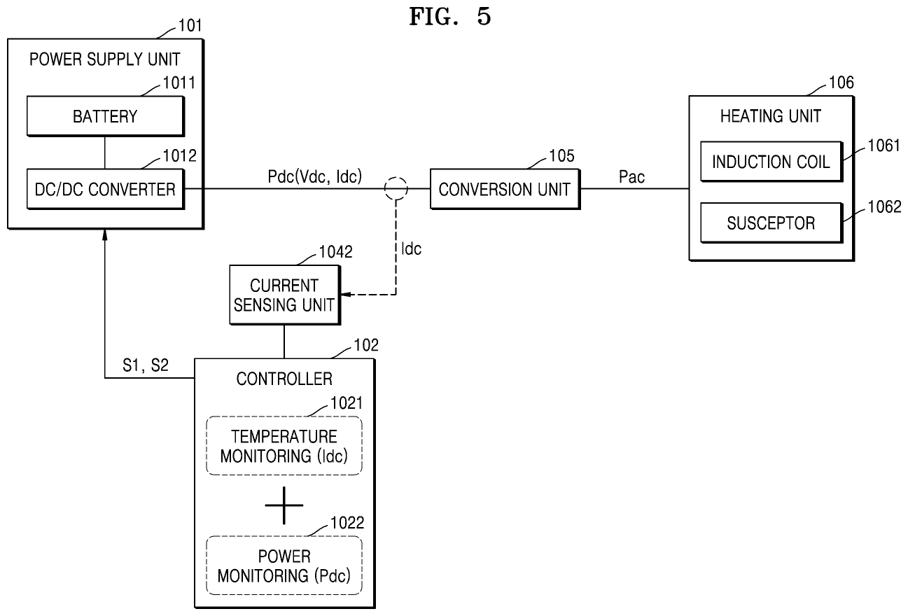

The power supply unit 101 may include a battery 1011 (see FIG. 5) and a direct current (DC)/DC converter 1012 (see FIG. 5).

The battery 1011 may include a detachable battery that is removably arranged in the aerosol generating device 1. Alternatively, the battery 1011 may be fixed to the aerosol generating device 1. In this case, the battery 1011 may be a rechargeable or disposable battery. For example, the battery 1011 may be a LiPoly battery, but embodiments are not limited thereto.

The DC/DC converter 1012 may be connected to the battery 1011 and may output a DC current. In detail, the DC/DC converter 1012 may include at least one switching element and may supply power to the internal components of the aerosol generating device 1 by boosting or lowering DC power provided from the battery 1011. To this end, the DC/DC converter 1012 may include at least one of a buck converter, a boost converter, and a buck-boost converter.

The power conversion unit 105 may convert the DC power output by the DC/DC converter 1012 into AC power. To this end, the power conversion unit 105 may include a DC/AC converter. The DC/AC converter may include at least one switching element and may be configured as an E-class or D-class power converter. Also, the power conversion unit 105 may include a full-bridge circuit or a half-bridge circuit including a plurality of field-effect transistors (FETs). The power conversion unit 105 may provide the AC power to the heating unit 106.

The heating unit 106 may include the induction coil 1061 and the susceptor 1062. The induction coil 1061 may generate an alternating magnetic field according to an AC current converted by the power conversion unit 105. The susceptor 1062 may be induced by the alternating magnetic field to heat an aerosol generating article inserted into the aerosol generating device 1. Accordingly, aerosols may be generated.

The susceptor 1062 may be arranged fixedly, rather than replaceably, in the aerosol generating device 1. However, embodiments are not limited thereto, and the susceptor 1062 may be replaceably arranged.

The sensing unit 104 may sense various state information of the aerosol generating device 1. A result sensed by the sensing unit 104 may be transmitted to the controller 102, and the controller 102 may, according to the sensed result, control the aerosol generating device 1 to perform various functions, such as controlling an operation of the heating unit 106, restricting smoking, determining insertion of the susceptor 1062, and displaying a notification.

The sensing unit 104 may include the substrate sensing unit 1041 and the current sensing unit 1042.

The substrate sensing unit 1041 may be implemented in a pattern shape on each insulating substrate. The substrate sensing unit 1041 may include a capacitance sensor or an inductive sensor. Accordingly, the substrate sensing unit 1041 may sense a capacitance change or an inductance change that occurs according to insertion and extraction of the aerosol generating article with respect to a cavity. The substrate sensing unit 1041 may transmit a capacitance value or an inductance value to the controller 102 in real time or periodically.

The current sensing unit 1042 may be connected between the DC/DC converter 1012 and the power conversion unit 105 (see FIG. 5). The current sensing unit 1042 may sense a DC current Idc output from the DC/DC converter 1012 to the heating unit 106. The current sensing unit 1042 may transmit information about the DC current Idc to the controller 102 in real time or periodically. The DC current Idc that has been sensed may be used to determine (estimate) a temperature of the susceptor 1062. Also, the DC current Idc that has been sensed may be used to determine (estimate) DC power Pdc provided to the heating unit 106.

The memory 103 may store data related to a temperature profile and data related to a power profile, for controlling a heating operation of the heating unit 106. Also, the memory 103 may store correlation data for calculating the temperature of the susceptor 1062 from the DC current Idc sensed by the current sensing unit 1042. That is, the memory 103 may store various types of data used by the controller 102 to control the heating operation of the heating unit 106.

When an aerosol generating article is inserted into the cavity, the controller 102 may control the heating unit 106 to heat the aerosol generating article. In an embodiment, the controller 102 may control DC power output from the power supply unit 101 and/or AC power supplied to the induction coil 1061, so that the induction coil 1061 may generate a variable magnetic field. The susceptor 1062 may be heated by the variable magnetic field generated by the induction coil 1061, thereby heating the inserted aerosol generating article.

The controller 102 may perform temperature monitoring for estimating the temperature of the susceptor 1062, based on the DC current Idc sensed by the current sensing unit 1042, and power monitoring for estimating the power Pdc supplied from the DC/DC converter 1012 to the power conversion unit 105, based on the DC current Idc that has been sensed. Then, the controller 102 may perform at least one of temperature-based feedback control and power-based feedback control for the DC/DC converter 1012, based on results of the temperature monitoring and the power monitoring.

In detail, the controller 102 may control heating of the aerosol generating article by controlling an operation of the heating unit 106 according to a target temperature and a target power based on a temperature profile and a power profile, which are stored in the memory 103.

To determine the temperature of the susceptor 1062 in direct contact with the aerosol generating article, the controller 102 may estimate the temperature of the susceptor 1062 by using the DC current Idc output from the DC/DC converter 1012, without a separate temperature sensor. The DC current Idc output from the DC/DC converter 1012 and the temperature of the susceptor 1062 may have a linear relationship. For example, the DC current Idc output from the DC/DC converter 1012 may decrease as the temperature of the susceptor 1062 increases, and conversely, the DC current Idc output from the DC/DC converter 1012 may increase as the temperature of the susceptor 1062 decreases. The controller 102 may determine the temperature of the susceptor 1062 based on the linear relationship between the DC current Idc and the temperature of the susceptor 1062, and may compare the determined temperature with the temperature profile, thereby controlling power supplied to the heating unit 106.

Also, the controller 102 may monitor whether the power Pdc provided to the induction coil 1061 to induce a variable magnetic field in the susceptor 1062 follows a target power preset in the power profile, by using the DC current Idc output from the DC/DC converter 1012 and a DC voltage Vdc applied by the DC/DC converter 1012.

That is, the controller 102 according to the present embodiment may simultaneously perform, as a feedback method for controlling the heating operation of the heating unit 106, feedback by monitoring the temperature of the heating unit 106 (the susceptor 1062) and feedback by monitoring the power provided to the heating unit 106 (the induction coil 1061). Here, temperature-based feedback control may include adjusting the intensity of the DC current Idc output from the DC/DC converter 1012 such that the estimated temperature follows a target temperature of the temperature profile, and power-based feedback control may include adjusting the intensity of the DC voltage Vdc applied by the DC/DC converter 1012 such that the power Pdc that has been estimated follows a target power of the power profile.

FIG. 5 is a diagram for explaining a method of performing temperature monitoring and power monitoring for a heating unit, according to an embodiment.

Referring to FIG. 5, the power supply unit 101 may output DC power Pdc to the power conversion unit 105. To this end, the power supply unit 101 may include the battery 1011 and the DC/DC converter 1012. The DC/DC converter 1012 may convert (boost or lower) DC power provided from the battery 1011 into DC power of a certain level and may apply the converted DC power to the power conversion unit 105. The converted (boosted or lowered) DC power may be provided to the power conversion unit 105 as a DC voltage Vdc and a DC current Idc. The DC voltage Vdc and the DC current Idc may be provided to the power conversion unit 105 as the DC power Pdc. Here, the level of the DC power Pdc output by the power supply unit 101 may be adjusted by feedback control by the controller 102.

The power conversion unit 105 may convert the DC power Pdc into AC power Pac. To this end, the power conversion unit 105 may include a DC/AC converter. The DC/AC converter may include at least one switching element (e.g., a FET) and may be configured as an E-class or D-class power converter. The power conversion unit 105 may convert the DC power Pdc into the AC power Pac and may output the AC power Pac, according to on/off of the switching element.

The induction coil 1061 of the heating unit 106 may receive the AC power Pac to generate an alternating magnetic field, and the susceptor 1062 may generate heat due to the alternating magnetic field to heat the inserted aerosol generating article.

The current sensing unit 1042 may sense the DC current Idc output by the DC/DC converter 1012. To this end, the current sensing unit 1042 may be implemented as a current sensor including a shunt resistor. However, the current detection method of the present embodiment is not limited thereto.

The controller 102 may perform temperature monitoring 1021 for the heating unit 106 by determining the current temperature of the susceptor 1062 based on the DC current Idc sensed by the current sensing unit 1042.

The susceptor 1062 may be considered as a resistance component when viewed from the DC/DC converter 1012, which is an input terminal. Accordingly, it may be considered that the size of the resistance component of the susceptor 1062 increases as the temperature of the susceptor 1062 increases, and thus, it may be considered that the DC current Idc sensed by the current sensing unit 1042 decreases as the temperature of the susceptor 1062 increases. In other words, a linear relationship may be formed between the temperature of the susceptor 1062 and the DC current Idc. In this manner, the controller 102 may perform the temperature monitoring 1021 for the susceptor 1062, based on the linear relationship between the temperature of the susceptor 1062 and the DC current Idc. Information about a correlation between the temperature of the susceptor 1062 and the DC current Idc may be stored in advance in the memory 103 as a lookup table or a calculation formula.

The controller 102 may control the intensity of the DC current Idc output by the DC/DC converter 1012 by calculating the current temperature of the susceptor 1062 from the DC current Idc and comparing the current temperature of the susceptor 1062 with a target temperature on a temperature profile. In this case, the controller 102 may control the level of the DC current Idc output by the DC/DC converter 1012 through a control signal S1 for temperature-based feedback.

The controller 102 may calculate the power Pdc currently provided to the power conversion unit 105, based on the DC current Idc sensed by the current sensing unit 1042 and the DC voltage Vdc applied by the DC/DC converter 1012. That is, the controller 102 may also perform power monitoring 1022 for the heating unit 106.

The controller 102 may control the intensity of the DC voltage Vdc applied by the DC/DC converter 1012 by comparing the current power with the target power on the power profile. In detail, the controller 102 may adjust the level of the DC voltage Vdc applied by the DC/DC converter 1012 through a control signal S2 for power-based feedback, thereby adjusting the level of the DC power Pdc provided to the power conversion unit 105. However, while the present embodiment shows an example in which the controller 102 controls only the level of the DC voltage Vdc applied by the DC/DC converter 1012 to adjust the DC power Pdc, embodiments are not limited thereto. The controller 102 may control only the level of the DC current Idc applied by the DC/DC converter 1012 or may control both the levels of the DC voltage Vdc and the DC current Idc to adjust the DC power Pdc.

As such, the controller 102 may simultaneously perform the temperature monitoring 1021 and the power monitoring 1022. The controller 102 may control the DC power Pdc to be output from the DC/DC converter 1012 by transmitting the control signal S1 for temperature-based feedback or the control signal S2 for power-based feedback based on a monitoring result. The AC power Pac to be converted by the power conversion unit 105 may be adjusted to a level corresponding to the level of the DC power Pdc, and thus, a heating operation (e.g., a susceptor temperature) of the heating unit 106 may also be controlled.

The aerosol generating device 1, which performs a heating operation, may correspond to a high-power device that consumes a relatively large amount of power. Accordingly, efficient control and stability of the battery 1011 provided in the aerosol generating device 1 may be important. A maximum power output that may be output from the battery 1011 and the DC/DC converter 1012 provided in the aerosol generating device 1 is limited, and it is difficult to achieve a greater output. Accordingly, power feedback control through the power monitoring 1022 may stably supply a desired level of output and may ensure the stability of the battery 1011. In comparison, because the temperature monitoring 1021 includes directly monitoring a state of a heater (the susceptor 1062), such as a temperature of the heater, temperature-based feedback control may enable more precise heating control. As such, the aerosol generating device 1 according to the present embodiment may achieve battery stability and battery efficiency by simultaneously performing the temperature monitoring 1021 and the power monitoring 1022.

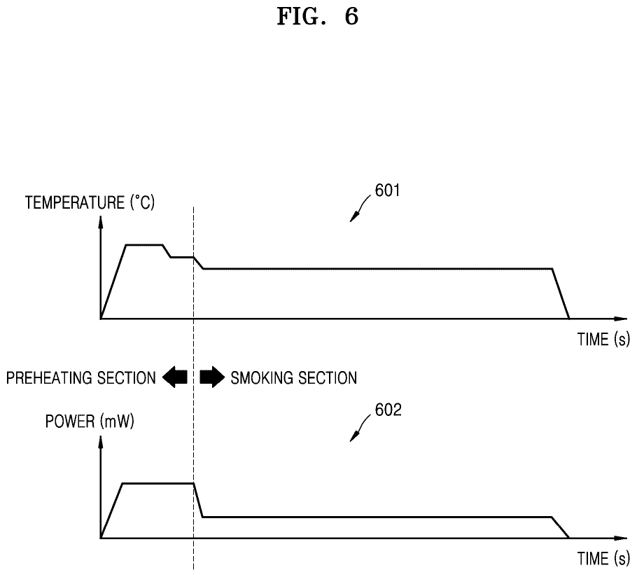

FIG. 6 is a diagram for explaining a temperature profile and a power profile according to an embodiment.

Referring to FIG. 6, a temperature profile 601 may represent target temperatures of a heater (the susceptor 1062) over time in the aerosol generating device 1. Also, a power profile 602 may represent target powers to be provided to a heater (the heating unit 106) over time in the aerosol generating device 1. In detail, the target powers of the power profile 602 may refer to target powers to be provided to the power conversion unit 105.

Referring to the temperature profile 601, after the start of an operation of the heater (the susceptor 1062), a preheating section where the temperature of the heater (the susceptor 1062) is rapidly increased for a certain period of time may be performed. When the preheating is complete, a smoking section where the user performs a puff may be performed. In the smoking section, the target temperature may remain almost constant until the end of smoking.

Referring to the power profile 602, the preheating section may include a section where output power is rapidly increased until a target preheating temperature of the heater (the susceptor 1062) is reached within a short period of time. A constant level of power may be supplied near a time point where the highest temperature (the target preheating temperature) on the temperature profile 601 is reached. In the smoking section, a relatively low target power level may be maintained compared to the preheating section.

However, the temperature profile 601 and the power profile 602 shown in FIG. 6 are arbitrary profiles provided for convenience of explanation, and profiles that may be used in the aerosol generating device 1 are not limited thereto.

The controller 102 may compare the current temperature obtained through the temperature monitoring 1021 at any monitoring time point with the target temperature on the temperature profile 601 at the monitoring time point. When, as a result of the comparison, it is determined that there is a difference between the current temperature and the target temperature, the controller 102 may perform temperature-based feedback control such that the current temperature follows the target temperature.

Similarly, the controller 102 may compare the current power obtained through the power monitoring 1022 at any monitoring time point with the target power on the power profile 602 at the monitoring time point. When, as a result of the comparison, it is determined that there is a difference between the current power and the target power, the controller 102 may perform power-based feedback control such that the current power follows the target power.

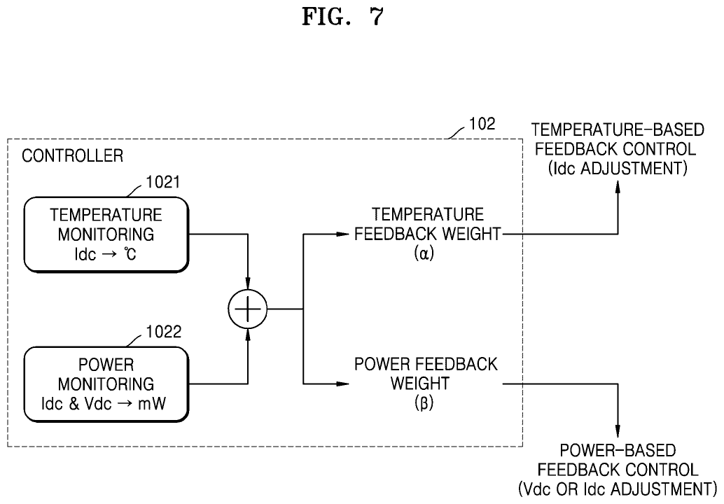

FIG. 7 is a diagram for explaining a method of performing temperature-based feedback control and power-based feedback control, according to an embodiment.

Referring to FIG. 7, the controller 102 may perform the temperature monitoring 1021 by calculating the current temperature of the heater (the susceptor 1062) based on the DC current Idc sensed by the current sensing unit 1042. In this case, there may be various methods of calculating the current temperature from the DC current Idc. For example, an experimentally obtained mathematical formula such as “current temperature (° C.)=(Idc*0.105)−80.48” may be used. However, embodiments are not limited thereto, and the current temperature may be calculated from the DC current Idc by using a lookup table or mathematical formulas with various other parameters.

The controller 102 may perform the power monitoring 1022 by calculating the current power (Pdc=Vdc*Idc) provided to the power conversion unit 105, based on the DC current Idc sensed by the current sensing unit 1042 and the DC voltage Vdc applied by the DC/DC converter 1012.

The controller 102 may perform at least one of temperature-based feedback control and power-based feedback control, based on a temperature feedback weight α set for temperature-based feedback control and a power feedback weight β set for power-based feedback control.

The controller 102 may directly determine a weight α for temperature-based feedback control and a weight β for power-based feedback control, or the controller 102 may use preset weights α and β. Here, the temperature feedback weight α and the power feedback weight β may be values that satisfy the relational expression “α+β=100%.” That is, while the controller 102 continuously performs the temperature monitoring 1021 and the power monitoring 1022 throughout the preheating section and the smoking section, temperature-based feedback control and power-based feedback control may be performed by reflecting the determined weights (α and β), respectively.

For example, it is assumed that the temperature feedback weight α is 50% and the power feedback weight β is 50%. As an example, when, as a result of the temperature monitoring 1021, the difference between the current temperature and the target temperature is 10° C., and, as a result of the power monitoring 1022, the difference between the current power and the target power is 500 mA, the controller 102 may perform temperature-based feedback control to compensate for 5° C., which is 50% of the temperature difference of 10° C., and perform power-based feedback control to compensate for 250 mA, which is 50% of the power difference of 500 mA. As another example, temperature-based feedback control may include controlling only a DC current corresponding to 50% of the DC current Idc that has been set to increase (or decrease), to compensate for the temperature difference of 10° C., and power-based feedback control may include controlling only a DC voltage corresponding to 50% of the DC voltage Vdc that has been set to increase (or decrease), to compensate for the power difference of 500 mA. However, these methods are only examples, and various other methods of determining the level of feedback control according to each weight may be applied to the present embodiment.

The controller 102 may perform PID control for temperature-based feedback control and power-based feedback control. PID control refers to a method of feedback control based on a value calculated by the sum of three terms proportional to an error value, an integral of the error value, and a derivative of the error value. By adjusting a coefficient (Kp) of the term proportional to the error value, control may be performed to be proportional to the size of the error value in the current state. By adjusting a coefficient (Ki) of the term proportional to the integral of the error value, control may be performed to reduce a steady-state error. By adjusting a coefficient (Kd) of the term proportional to the derivative of the error value, control may be performed to reduce a rapid change in an output value, thereby reducing overshoot and improving stability.

That is, the controller 102 may perform feedback control such that the current temperature/power converges to the target temperature/target power by adjusting the coefficients (Kp, Ki, and Kd) of the three terms for PID control. Here, the coefficients (Kp, Ki, and Kd) of the three terms for PID control may be adjusted by the weights α and β described above. In other words, the controller 102 may determine the coefficients (Kp, Ki, and Kd) of PID control, based on the temperature feedback weight α and the power feedback weight β.

The controller 102 may determine the temperature feedback weight α and the power feedback weight β according to various criteria.

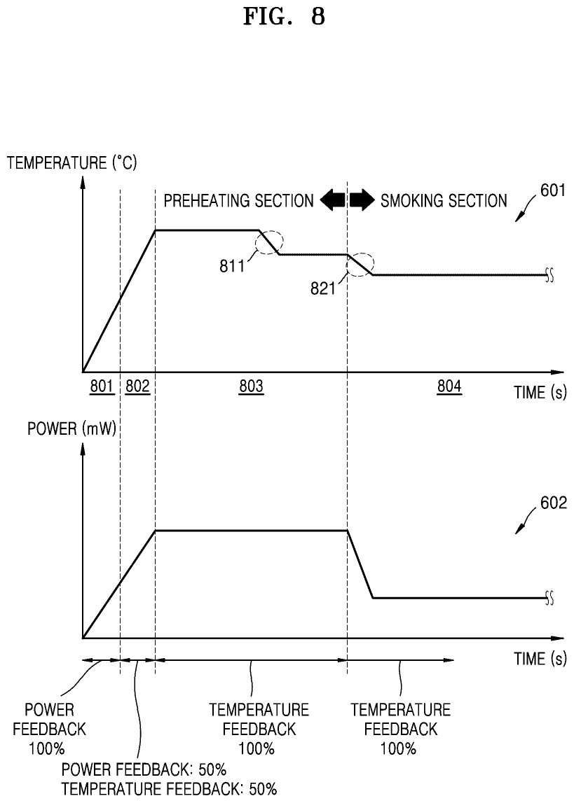

In an example, the temperature feedback weight α and the power feedback weight β may be preset for each section of the temperature profile or the power profile. This aspect will be described below with reference to the example shown in FIG. 8.

FIG. 8 is a diagram for explaining feedback weights set for each section of a profile, according to an embodiment.

Referring to FIG. 8, in an early stage 801 (a first stage) of the preheating section, which is a portion of the preheating section, the temperature feedback weight α may be preset to 0%, and the power feedback weight β may be preset to 100%. When preheating starts, the heater (the susceptor 1062) requires rapid temperature changes to reach a target preheating temperature within a short period of time, and thus, temperature feedback may be difficult. Accordingly, it may be desirable to perform only power-based feedback control in the early stage 801 of the preheating section.

In a middle stage 802 (a second stage) of the preheating section, which is another portion of the preheating section, the temperature feedback weight α may be preset to 50%, and the power feedback weight β may be preset to 50%. While rapid temperature changes still occur for the heater (the susceptor 1062), it needs to be monitored whether the target preheating temperature is reached, and thus, temperature monitoring may also be required. Accordingly, in the middle stage 802 of the preheating section, it may be desirable to perform temperature-based feedback control and power-based feedback control together.

In a late stage 803 (a third stage) of the preheating section, which is another portion of the preheating section, the temperature feedback weight α may be preset to 100%, and the power feedback weight β may be preset to 0%. When the target preheating temperature on the temperature profile is reached, the heater (the susceptor 1062) may be controlled to maintain the target preheating temperature for a certain period of time. Accordingly, in the late stage 803 of the preheating section, it may be desirable to place greater importance on temperature-based feedback control.

When a smoking section 804 starts, the heater (the susceptor 1062) may be controlled to maintain a relatively constant temperature without rapid temperature changes. Accordingly, it may be desirable to place more importance on temperature-based feedback control, and thus, the temperature feedback weight α may be preset to 100%, and the power feedback weight β may be preset to 0%.

The weight presets described with reference to FIG. 8 are only examples, and the present embodiment is not limited thereto. That is, weight presets may be set differently from those in FIG. 8 depending on various device conditions, such as temperature profile, power profile, or heater type, and such weight presets may also be included in the scope of application of the present embodiment.

Referring again to FIG. 7, the temperature feedback weight α and the power feedback weight β may be preset according to different criteria. In detail, in sections where rapid temperature changes occur on the temperature profile, the temperature feedback weight α and the power feedback weight β may each be preset to 50%. For example, in the middle stage 802 of the preheating section and lowering sections 811 and 821, the temperature feedback weight α and the power feedback weight β may each be preset to 50%.

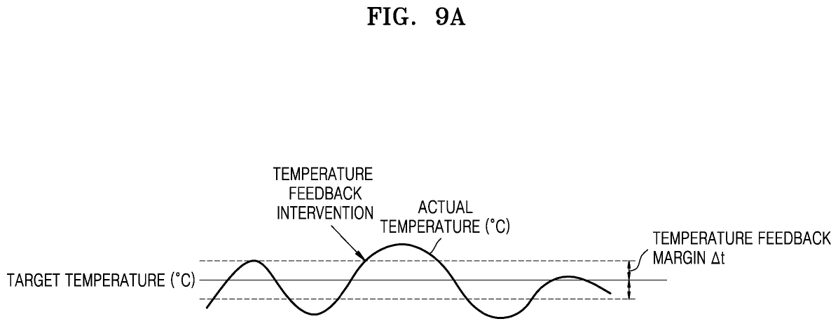

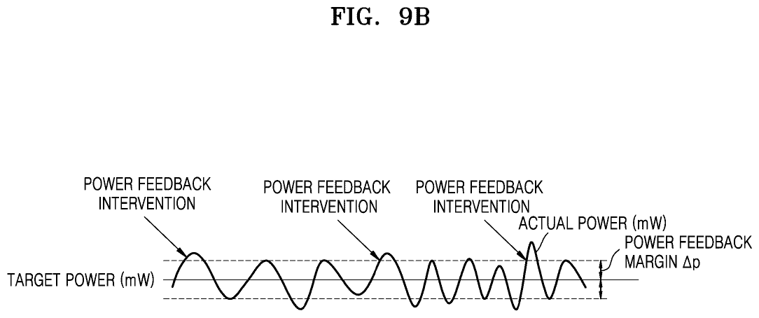

According to another criterion, when a result of the temperature monitoring 1021 or the power monitoring 1022 is monitored to be outside a predetermined feedback margin (Δ), the controller 102 may intervene in feedback. This aspect will be described with reference to the examples shown in FIGS. 9A and 9B.

FIGS. 9A and 9B are diagrams for explaining a method of performing temperature-based feedback control and power-based feedback control, based on a feedback margin, according to an embodiment.

Referring to FIG. 9A, target temperatures are preset on the temperature profile, and actual temperatures may be obtained in real time through temperature monitoring. In a case where the temperature feedback weight α is 0% in any section, the controller 102 may not perform temperature-based feedback control even when performing temperature monitoring. However, when the current temperature is monitored to be outside a temperature feedback margin (Δt) set based on a target temperature, the controller 102 may intervene in feedback control even in a section where the temperature feedback weight α is 0%. That is, even in a case where the current section is preset to perform only power-based feedback control, when the current temperature differs excessively from the target temperature through temperature monitoring, temperature-based feedback control may be additionally performed.

Similarly, referring to FIG. 9B, target powers are preset on the power profile, and actual powers may be obtained in real time through power monitoring. The controller 102 may not perform power-based feedback control in a section where the power feedback weight β is 0%. However, when the current power is monitored to be outside a power feedback margin (Δp) set based on a target power, the controller 102 may perform power-based feedback control even in a section where the power feedback weight β is 0%.

Referring again to FIG. 7, the controller 102 may continuously perform the temperature monitoring 1021 and the power monitoring 1022 from the start to the end of an operation of the heater (the heating unit 106). Also, the controller 102 may perform temperature-based feedback control or power-based feedback control according to the temperature feedback weight α and the power feedback weight β.

Here, temperature-based feedback control may refer to controlling the temperature of the heater (the susceptor 1062) to follow a target temperature on the temperature profile, by controlling the intensity of the DC current Idc flowing from the DC/DC converter 1012 to the power conversion unit 105.

Also, power-based feedback control may refer to controlling the power supplied to the heater (the heating unit 106) to follow a target power on the power profile, by controlling the intensity of the DC voltage Vdc applied to the power conversion unit 105 by the DC/DC converter 1012 or the intensity of the DC current Idc flowing from the DC/DC converter 1012 to the power conversion unit 105.

In power-based feedback control, a situation may arise where the power Pdc as desired is not supplied simply by adjusting the intensity (level) of the DC voltage Vdc. This is because as the temperature of the susceptor 1062 increases, the value of the resistance component of the susceptor 1062 increases. Because power decreases as resistance increases, the power Pdc as desired may not be output from the DC/DC converter 1012 even when the intensity (level) of the DC voltage Vdc is increased. In such a case, the controller 102 may additionally adjust the frequency of the DC voltage Vdc. That is, the controller 102 may perform feedback control such that the power Pdc as desired is output from the DC/DC converter 1012 by simultaneously controlling the intensity (level) of the DC voltage Vdc and the frequency of the DC voltage Vdc.

In the embodiments described above, only a case where the temperature feedback weight α and the power feedback weight β are each set to 50% has been described. However, such an example is provided only for convenience of explanation, and the present embodiment is not limited thereto. That is, each of the temperature feedback weight α and the power feedback weight β may be set to weights of various values.

As described above, the aerosol generating device 1 may stably output a desired level of power through power feedback control and simultaneously perform precise temperature control through temperature feedback control, and thus, stability and efficiency of the battery 1011 may be achieved while the aerosol generating article may be heated to an optimized temperature, thereby providing the user with an improved smoking feeling.

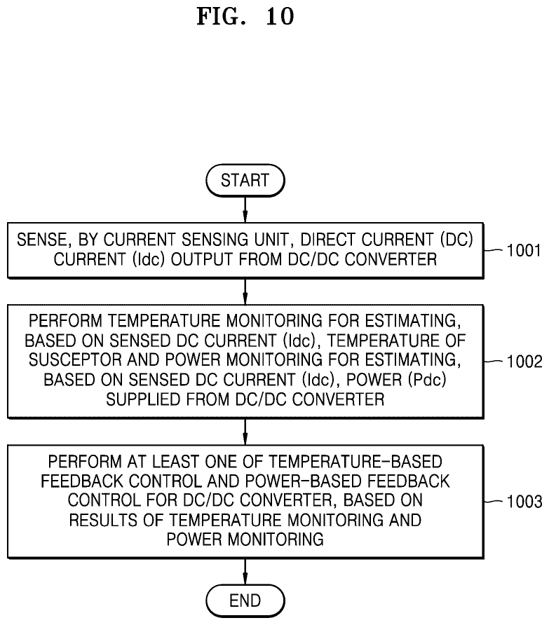

FIG. 10 is a flowchart of a method of controlling an aerosol generating device, according to an embodiment.

Referring to FIG. 10, a method of controlling the aerosol generating device 1 corresponds to operations to be processed in time series in the aerosol generating device 1 described above with reference to the drawings. Accordingly, even when omitted below, the descriptions provided above with reference the drawings may also be applied to the method of FIG. 10.

In operation 1001, the current sensing unit 1042 connected between the DC/DC converter 1012, which is connected to the battery 1011 and outputs a DC current, and the power conversion unit 105, which converts the DC current provided from the DC/DC converter 1012 into an AC current, may sense a DC current Idc output from the DC/DC converter 1012.

In operation 1002, the controller 102 may perform temperature monitoring for estimating a temperature of the susceptor 1062, based on the DC current Idc that has been sensed, and power monitoring for estimating power Pdc supplied from the DC/DC converter 1012, based on the DC current Idc that has been sensed.

In operation 1003, the controller 102 may perform at least one of temperature-based feedback control and power-based feedback control for the DC/DC converter 1012, based on results of the temperature monitoring and the power monitoring.

Certain embodiments or other embodiments of the disclosure described above are not exclusive or distinct from each other. The certain embodiments or other embodiments of the disclosure described above may be combined with each other or used in combination with each other in their respective components or functions.

For example, it means that an A component described in a specific embodiment and/or the drawings and a B component described in another embodiment and/or the drawings may be combined with each other. In other words, even when it is not explained directly about combination between components, it is possible to combine unless it is explained that combination is impossible.

The above detailed description should not be interpreted restrictively and should be considered illustrative, in all aspects. The scope of the disclosure should be determined by a rational interpretation of the attached claims, and all changes within the equivalent scope of the disclosure are included in the scope of the disclosure.

According to the above description, an aerosol generating device may stably output a desired level of power through power feedback control and simultaneously perform precise temperature control through temperature feedback control, and thus, stability and efficiency of a battery may be achieved while an aerosol generating article may be heated to an optimized temperature, thereby providing a user with an improved smoking feeling.

What is claimed is:

1. An aerosol generating device comprising:
a direct current (DC)/DC converter connected to a battery and configured to output a DC current;
a power conversion unit configured to convert the DC current provided from the DC/DC converter into an alternating current (AC) current;
a heating unit comprising an induction coil and a susceptor, the induction coil being configured to generate an alternating magnetic field due to the AC current, and the susceptor being configured to, by being induced by the alternating magnetic field, heat an aerosol generating article inserted into the aerosol generating device;
a current sensing unit connected between the DC/DC converter and the power conversion unit and configured to sense the DC current output from the DC/DC converter; and
a controller configured to perform temperature monitoring for estimating, based on the sensed DC current, a temperature of the susceptor and power monitoring for estimating, based on the sensed DC current, power supplied from the DC/DC converter to the power conversion unit, and to perform at least one of temperature-based feedback control and power-based feedback control for the DC/DC converter, based on results of the temperature monitoring and the power monitoring.

2. The aerosol generating device of claim 1, wherein the temperature-based feedback control comprises adjusting an intensity of the DC current output from the DC/DC converter such that the estimated temperature follows a target temperature on a temperature profile, and
the power-based feedback control comprises adjusting an intensity of a DC voltage applied by the DC/DC converter such that the estimated power follows a target power on a power profile.

3. The aerosol generating device of claim 1, wherein the controller is further configured to perform at least one of the temperature-based feedback control and the power-based feedback control, based on a temperature feedback weight set for the temperature-based feedback control and a power feedback weight set for the power-based feedback control.

4. The aerosol generating device of claim 3, wherein the temperature feedback weight is set to 0% in a first stage of a preheating section on a temperature profile, and
the controller is further configured to perform only the power-based feedback control in the first stage of the preheating section.

5. The aerosol generating device of claim 3, wherein the temperature feedback weight is set to 50% in a second stage of a preheating section on a temperature profile,
the power feedback weight is set to 50% in the second stage, and
the controller is further configured to perform the temperature-based feedback control and the power-based feedback control together in the second stage of the preheating section.

6. The aerosol generating device of claim 3, wherein the temperature feedback weight is set to 100% in at least a portion of a smoking section on a temperature profile, and
the controller is further configured to perform only the temperature-based feedback control in the at least a portion of the smoking section.

7. The aerosol generating device of claim 3, wherein the controller is further configured to:
perform the temperature-based feedback control when the estimated temperature is outside a preset temperature feedback margin, even at a time point where the temperature feedback weight is 0%; and
perform the power-based feedback control when the estimated power is outside a preset power feedback margin, even at a time point where the power feedback weight is 0%.

8. The aerosol generating device of claim 1, further comprising a memory storing a temperature profile and a power profile, the temperature profile representing target temperatures of the susceptor over time, and the power profile representing target powers to be provided to the heating unit over time,
wherein the controller is further configured to perform the temperature monitoring and the power monitoring by using the temperature profile and the power profile from a start to an end of an operation of the heating unit.

9. The aerosol generating device of claim 1, wherein the temperature-based feedback control and the power-based feedback control comprise proportional-integral-differential (PID) control, and
the controller is further configured to determine coefficients for performing the PID control, based on a temperature feedback weight set for the temperature-based feedback control and a power feedback weight set for the power-based feedback control.

10. A method of controlling an aerosol generating device, the method comprising:
sensing, by a current sensing unit connected between a direct current (DC)/DC converter and a power conversion unit, a DC current, the DC/DC converter being connected to a battery and configured to output the DC current, and the power conversion unit being configured to convert the DC current provided from the DC/DC converter into an alternating current (AC) current;
performing, by a controller, temperature monitoring for estimating, based on the sensed DC current, a temperature of a susceptor and power monitoring for estimating, based on the sensed DC current, power supplied from the DC/DC converter to the power conversion unit; and
performing, by the controller, at least one of temperature-based feedback control and power-based feedback control for the DC/DC converter, based on results of the temperature monitoring and the power monitoring.

11. The method of claim 10, wherein the temperature-based feedback control comprises adjusting an intensity of the DC current output from the DC/DC converter such that the estimated temperature follows a target temperature on a temperature profile, and
the power-based feedback control comprises adjusting an intensity of a DC voltage applied by the DC/DC converter such that the estimated power follows a target power on a power profile.

12. The method of claim 10, wherein the performing of the at least one of the temperature-based feedback control and the power-based feedback control comprises performing at least one of the temperature-based feedback control and the power-based feedback control, based on a temperature feedback weight set for the temperature-based feedback control and a power feedback weight set for the power-based feedback control.

13. The method of claim 12, wherein the temperature feedback weight is set to 0% in a first stage of a preheating section on a temperature profile,
the temperature feedback weight is set to 50% in a second stage of the preheating section on the temperature profile,
the power feedback weight is set to 50% in the second stage, and
the temperature feedback weight is set to 100% in at least a portion of a smoking section on the temperature profile.

14. The method of claim 10, wherein the temperature monitoring and the power monitoring are performed by using a temperature profile and a power profile from a start to an end of heating of the susceptor.
